(19) United States
(12) Patent Application Publication
(10) Pub. No.: US 2006/0095352 A1
(43) Pub. Date: May 4, 2006

(54) Method and system for determining incremental return on invested capital

(76) Inventor: Jeffrey T. Sprague, Harrison, NY (US)

Correspondence Address: MILBANK, TWEED, HADLEY & MCCLOY, 1 CHASE MANHATTAN PLAZA, NEW YORK, NY, 10005-1413, US

(21) Appl. No.: 10/978,021

(22) Filed: Oct. 29, 2004

(51) Int. Cl. G06Q 40/00

(52) U.S. Cl. 705/35

(57) ABSTRACT

Incremental return on invested capital is determined by dividing the change in net operating profit after tax (NOPAT) by the change in invested capital (IC). NOPAT is net income, plus amortization, plus net interest on debt, plus net after-tax charges. IC is adjusted book value of equity, plus pooling premiums, plus cumulative goodwill, plus cumulative net after-tax charges. Trends for future incremental return on invested capital are estimated from price earnings (P/E) ratios, with the estimates of incremental return on invested capital generally one or two years forward from the P/E.

### BACKGROUND

The invention relates to the field of assessing company performance, and more particularly to assessing incremental changes in return on invested capital.

Analysts and investment managers consider many factors for individual companies and also for groups of companies. One of those factors is return on invested capital (often referred to as ROIC). Another factor is change in return on invested capital.

Techniques or factors are needed that will more accurately consider earnings and the cost of capital in the current period, without the sunk cost or benefit of ROIC from prior periods. Techniques or factors are also needed that will show the direction of ROIC and whether management actions are boosting or detracting from returns.

The preceding description is not to be construed as an admission that any of the description is prior art relative to the present invention.

### SUMMARY OF THE INVENTION

In one embodiment, the invention provides a system and method for determining incremental return on invested capital. The system and method determine net operating profit after tax at a first predetermined time, and determine invested capital at the first determined time. The system and method also determine net operating profit after tax at a second predetermined time, and determine invested capital at the second predetermined time. The system and method also determine a change in net operating profit after tax between the first predetermined time and the second predetermined time. The system and method also determine a change in invested capital between the first predetermined time and the second predetermined time, and determine the incremental return on invested capital by dividing the change in net operating profit after tax by the change in invested capital.

In another embodiment, the invention provides a system and method for determining incremental return on invested capital, wherein determining net operating profit after tax further comprises adding at least one of amortization, net interest on debt, and net after-tax charges to net income.

In another embodiment, the invention provides a system and method for determining incremental return on invested capital, wherein determining net operating profit after tax further comprises adding each of amortization, net interest on debt, and net after-tax charges to net income.

In another embodiment, the invention provides a system and method for determining incremental return on invested capital, wherein determining invested capital further comprises adding total debt to adjusted equity.

In another embodiment, the invention provides a system and method for determining incremental return on invested capital, wherein determining invested capital further comprises adding at least one of pooling premiums, cumulative goodwill, and cumulative net after-tax charges to book value of equity.

In another embodiment, the invention provides a system and method for determining incremental return on invested capital, wherein determining invested capital further comprises adding each of pooling premiums, cumulative goodwill, and cumulative net after-tax charges to book value of equity.

In another embodiment, the invention provides a system and method for determining incremental return on invested capital, wherein the second predetermined time is approximately one year after the first predetermined time.

In another embodiment, the invention provides a system and method for determining incremental return on invested capital, wherein the net operating profit after tax and the invested capital at the first and second predetermined times are from an individual company.

In another embodiment, the invention provides a system and method for determining incremental return on invested capital, wherein the net operating profit after tax and the invested capital at the first and second predetermined times are from a group of companies.

In another embodiment, the invention provides a system and method for estimating a trend of future incremental return on invested capital. The system and method comprise determining a relative forward price to earnings ratio, and estimating the trend of incremental return on invested capital at a predetermined future time using the relative forward price to earnings ratio. In this embodiment the incremental return on invested capital is the result of: determining net operating profit after tax at a first predetermined time; determining invested capital at the first predetermined time; determining net operating profit after tax at a second predetermined time; determining invested capital at the second predetermined time; determining a change in net operating profit after tax between the first predetermined time and the second predetermined time; determining a change in invested capital between the first predetermined time and the second predetermined time; and determining the incremental return on invested capital by dividing the change in net operating profit after tax by the change in invested capital.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to one embodiment of the invention;

FIG. 2 illustrates an example method according to one embodiment of the invention;

FIG. 3 illustrates an individual company relative forward PE vs IROIC in real time;

FIG. 4 illustrates an individual company two-year prior relative forward PE superimposed on current year IROIC;

FIG. 5 illustrates group relative forward PE vs group IROIC in real time; and

FIG. 6 illustrates group two-year prior relative forward PE superimposed on current year IROIC.

It is understood that the drawings are for illustration only and are not limiting.

### DETAILED DESCRIPTION OF THE DRAWINGS

The instant invention is directed to calculation of an incremental return on invested capital (IROIC), which is related to Return On Invested Capital.

Return on Invested Capital

Return on invested capital is often referred to as ROIC, and in a simplistic form, it might be calculated as:

$$ROIC = \frac{Net income after tax}{Invested capital}$$

In a somewhat more involved calculation, ROIC might be calculated as:

$$ROIC = \frac{Inc}{Cap} ,$$

where, Inc=After tax operating earnings, and

Cap=Total assets−Excess cash−Non-interest-bearing current liabilities.

It is also possible to calculate a change, or delta (Δ) in the ROIC as determined at two different periods, such as:
ΔROIC=ROIC₁−ROIC₂

where, ROIC₁ is a Return On Invested Capital, as determined at one point in time, and ROIC₂ is a Return on Invested Capital, as determined at a different point in time.

Incremental Return on Invested Capital

In various embodiments, the instant invention uses some of the same factors that are used to determine ROIC. However, those same factors are used in different ways to generate different measures of performance. In one such embodiment, the invention determines an Incremental Return On Invested Capital (IROIC), as:

$$IROIC = \frac{Change in net operating profit after tax}{Change in invested capital}$$

In this embodiment, the Net operating profit after tax, (often referred to as NOPAT), is generally calculated as:
NOPAT=Net income+Amortization+Net interest on debt+Net after-tax charges.

The Invested capital (often referred to as IC), is generally calculated as Adjusted equity+Total debt, where Adjusted equity is generally calculated as:
Adjusted Equity=Book value of equity+Pooling premiums+Cumulative good will and intangibles+Cumulative net after tax charges.

Change in ROIC and IROIC are different concepts that produce different and sometimes conflicting results. Change in ROIC represents the small impact that relative changes in NOPAT and IC in one period can have on the ROIC figure that a company or group of companies has accumulated over every period since inception. Thus, changes in ROIC will be small for most companies or groups, as they have built up large amounts of invested capital over many periods, and adding one period of change will not have much impact.

IROIC is different from change in ROIC, because it examines two periods in isolation to better capture the current operating performance of the company. In this manner, the effects of ROIC in all prior periods can be considered a sunk cost or benefit. Using IROIC allows evaluation of whether the company is earning more than its cost of capital in the current period. Example financial data from a company helps to illustrate the differences between change in ROIC and IROC:

| | 2001 | 2002 | 2003 |
|---|---|---|---|
| Net Income | | 14118 | 15566 |
| +Goodwill Amortization | | 0 | 0 |
| +Net Interest on Debt | | 417 | 1025 |
| +Net after tax charges | | 1015 | 0 |
| NOPAT | | 15550 | 16591 |
| Book Value of Equity | 54824 | 63706 | 70622 |
| +Pooling premiums | 0 | 0 | 0 |
| +Cumulative goodwill | 7003 | 7003 | 7003 |
| +Cum net after tax charges | 444 | 1459 | 2046 |
| Adjusted Equity | 62271 | 72168 | 79671 |
| Total Debt | 2509 | 9756 | 11000 |
| Invested Capital (IC) | 64780 | 81924 | 90671 |
| Average IC 2001-2002 | | 73352 | |
| Average IC 2002-2003 | | | 86297.5 |

As the example data shows, in 2002 the company earned a NOPAT of $15.6 billion on an average (2001-2002) Invested Capital (IC) of $73.4 billion. This equates to ROIC in 2002 of 21.2%. In 2003, the company earned a NOPAT of $16.6 billion on an average IC of $86.3 billion. This equates to ROIC in 2003 of 19.2%. The change in ROIC from 2002 to 2003 is a decline of 3%.

Calculation of IROIC provides a different view. The change in NOPAT from 2002 to 2003 is an increase of $1 billion, and the change of IC is an increase of $8.7 billion. Thus, IROIC from 2002 to 2003 is 1/8.7, or 11.9%.

An Example System

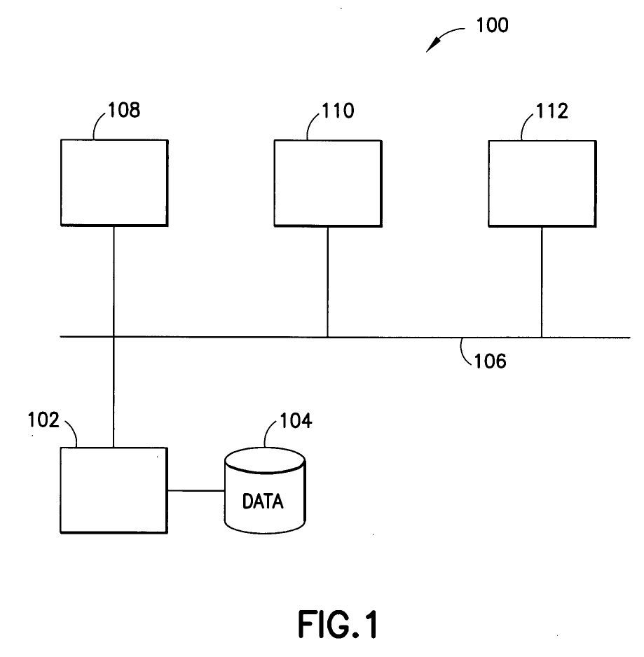

Referring to FIG. 1, system 100 in an example embodiment includes general purpose computer 102. Depending on the amount of data, system 100 may also include dedicated data storage 104. Link 106 connects or links computer 102 to sources of financial and performance information 108-112. Computer 102 typically includes a processor, memory, code storage, input/output devices, display devices and network connections. Link 106 is typically a wired or wireless connection, and may be connected to or include the Internet.

Sources 108-112 are frequently also general purpose computers, with associated processor, memory, code storage, input/output devices, display devices and network connections, and may include financial information from the published annual reports of individual companies, reports compiled from annual reports, and a number of other known sources. Data from sources 108-112 is typically, but not necessarily, available in electronic form.

An Example Method

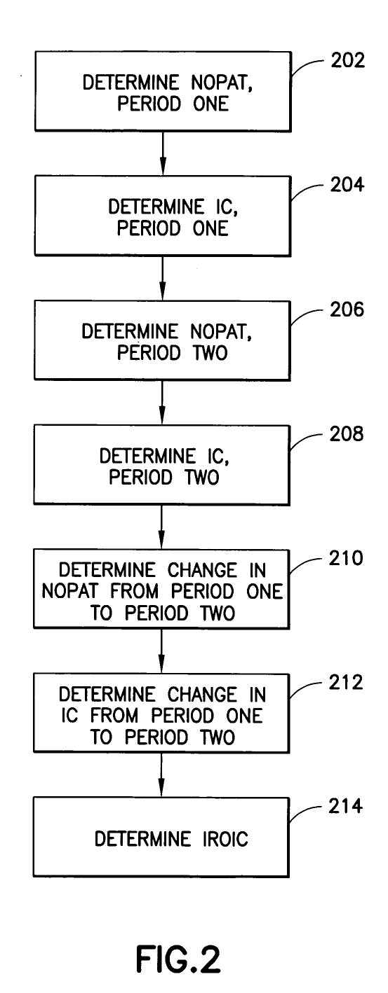

Referring now to FIG. 2, at step 202, system 100 determines Net Operating Profit After Tax (NOPAT) for a company or group of companies at a first predetermined time, using information such as from sources 108-112. NOPAT is typically net income, plus amortization, plus net interest on debt, plus net after-tax charges.

At step 204, system 100 determines Invested Capital (IC) for the company or group of companies at the first predetermined time, using information such as from sources 108-112. IC is determined by adding total debt to adjusted equity, where adjusted equity is typically book value of equity, plus pooling premiums, plus cumulative goodwill, plus cumulative net after-tax charges.

At step 206, system 100 determines NOPAT at a second predetermined time, again using information such as from sources 108-112.

At step 208, system 100 determines IC at the second predetermined time, again using information such as from sources 108-112.

At step 210, system 100 determines the change in NOPAT between the two predetermined times, and at step 212, system 100 determines the change in IC between the two predetermined times.

At step 214, system 100 determines IROIC by dividing the change in NOPAT by the change in IC.

Prediction of IROIC

IROIC is a measure of how well a company or group of companies is extracting profit from added investment. Analysis of past performance of a significant number of companies seems to indicate that relative valuations lead changes in IROIC by one to two years. In particular, changes in relative P/E seem to predict changes in IROIC one year forward about 50% of the time, and changes in relative P/E seem to predict changes in IROIC two years forward about 80% of the time.

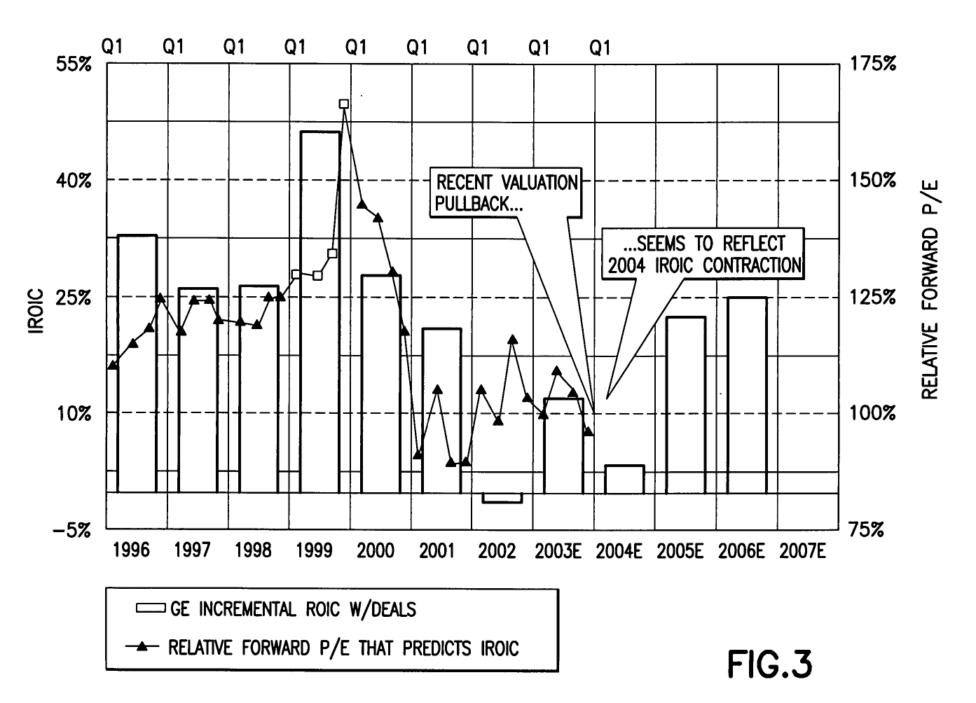

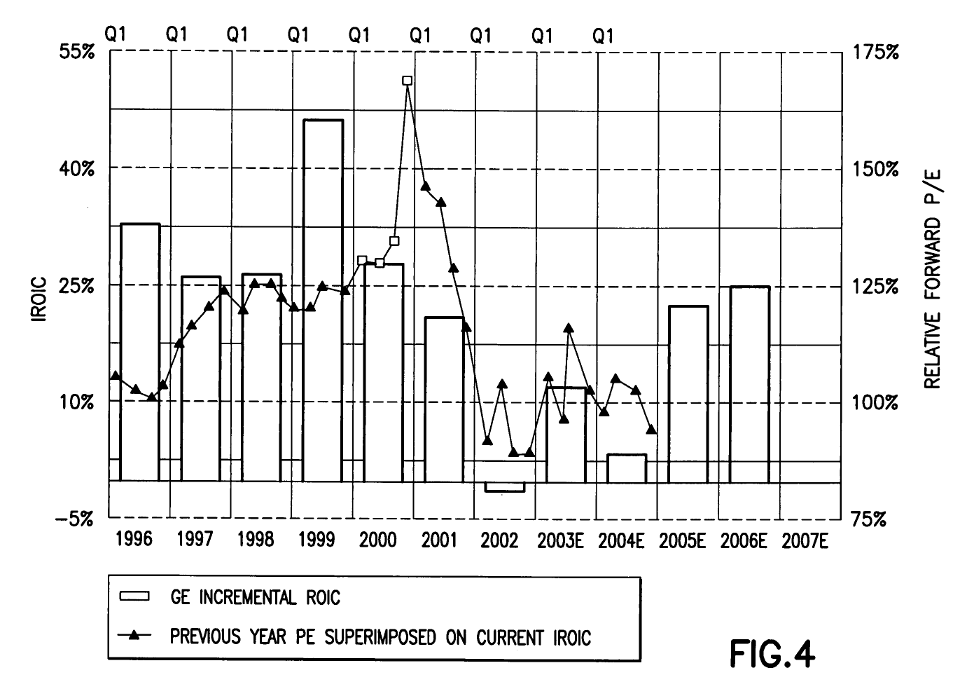

Reference to FIGS. 3 and 4 illustrate for an individual company the relationship between relative forward P/E and IROIC. FIG. 3 plots P/E and IROIC in real time, and FIG. 4 superimposes the two-year prior P/E on the current year IROIC, to better illustrate the relationship.

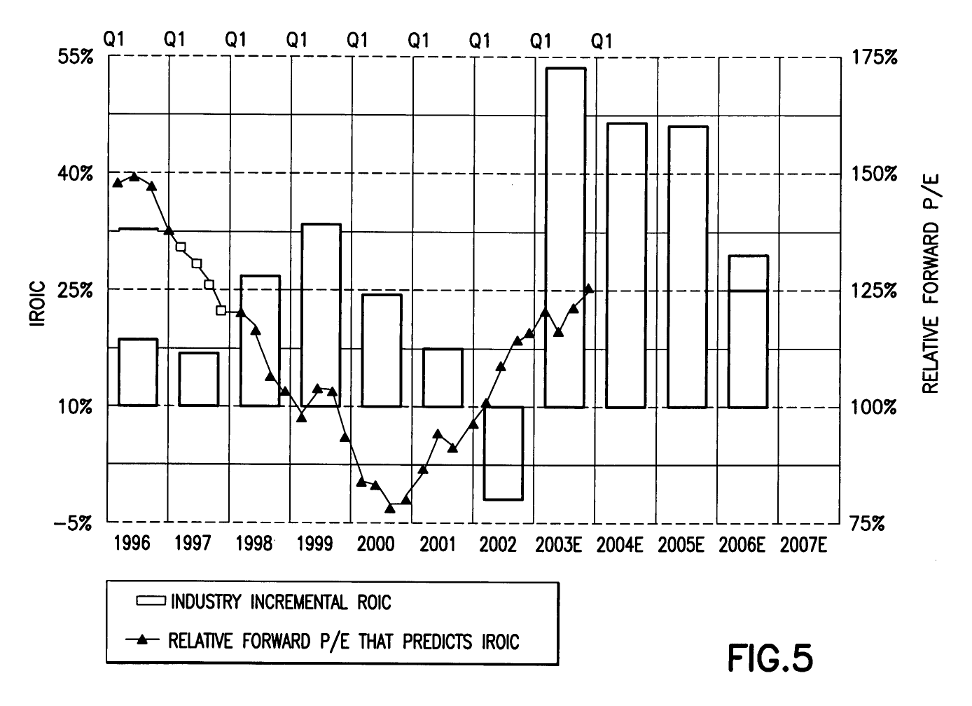

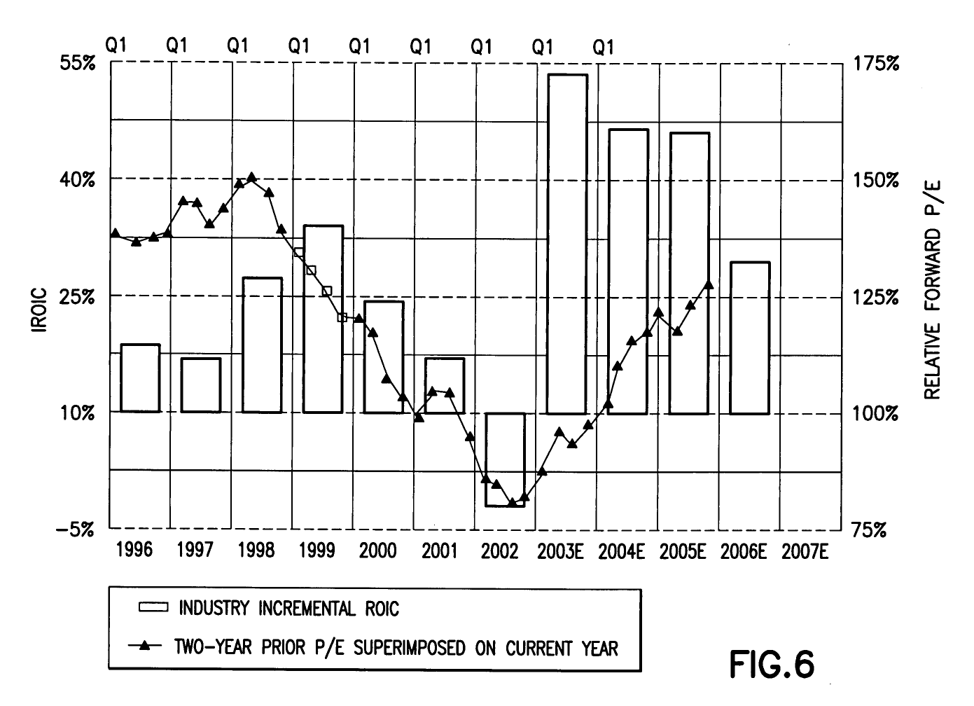

Reference to FIGS. 5 and 6 illustrate for an industry group the relationship between relative forward P/E and IROIC. Again, FIG. 5 plots P/E and IROIC in real time, and FIG. 6 superimposes the two-year prior P/E on the current year IROIC, to better illustrate the relationship. This observed relationship indicates that it is possible to predict future IROIC using P/E with some level of certainty.

Although illustrative embodiments have been described herein in detail, it should be noted and will be appreciated by those skilled in the art that numerous variations may be made within the scope of this invention without departing from the principles of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for determining incremental return on invested capital, the method comprising:
determining net operating profit after tax at a first predetermined time;
determining invested capital at the first predetermined time;
determining net operating profit after tax at a second predetermined time;
determining invested capital at the second predetermined time;
determining a change in net operating profit after tax between the first predetermined time and the second predetermined time;
determining a change in invested capital between the first predetermined time and the second predetermined time; and
determining the incremental return on invested capital by dividing the change in net operating profit after tax by the change in invested capital.

2. A method according to claim 1, wherein determining net operating profit after tax further comprises adding at least one of amortization, net interest on debt, and net after-tax charges to net income.

3. A method according to claim 1, wherein determining net operating profit after tax further comprises adding each of amortization, net interest on debt, and net after-tax charges to net income.

4. A method according to claim 1, wherein determining invested capital further comprises adding total debt to adjusted equity.

5. A method according to claim 1, wherein determining invested capital further comprises adding at least one of pooling premiums, cumulative goodwill, and cumulative net after-tax charges to book value of equity.

6. A method according to claim 1, wherein determining invested capital further comprises adding each of pooling premiums, cumulative goodwill, and cumulative net after-tax charges to book value of equity.

7. A method according to claim 1, wherein the second predetermined time is approximately one year after the first predetermined time.

8. A method according to claim 1, wherein the net operating profit after tax and the invested capital at the first and second predetermined times are from an individual company.

9. A method according to claim 1, wherein the net operating profit after tax and the invested capital at the first and second predetermined times are from a group of companies.

10. A method for determining incremental return on invested capital, the method comprising:
determining net operating profit after tax at a first predetermined time, where net operating profit after tax includes net income, plus amortization, plus net interest on debt, plus net after-tax charges;
determining invested capital at the first predetermined time, where invested capital includes book value of equity, plus pooling premiums, plus cumulative goodwill, plus cumulative net after-tax charges, plus total debt;
determining net operating profit after tax at a second predetermined time that is approximately one year after the first predetermined time, where net operating profit after tax includes net income, plus amortization, plus net interest on debt, plus net after-tax charges;
determining invested capital at the second predetermined time, where invested capital includes book value of equity, plus pooling premiums, plus cumulative goodwill, plus cumulative net after-tax charges, plus total debt;
determining a change in net operating profit after tax between the first predetermined time and the second predetermined time;
determining a change in invested capital between the first predetermined time and the second predetermined time; and
determining the incremental return on invested capital by dividing the change in net operating profit after tax by the change in invested capital.

11. A system for determining incremental return on invested capital, the system comprising:
means for determining net operating profit after tax at a first predetermined time;
means for determining invested capital at the first predetermined time;
means for determining net operating profit after tax at a second predetermined time;
means for determining invested capital at the second predetermined time;
means for determining a change in net operating profit after tax between the first predetermined time and the second predetermined time;
means for determining a change in invested capital between the first predetermined time and the second predetermined time; and
means for determining the incremental return on invested capital by dividing the change in net operating profit after tax by the change in invested capital.

12. A system according to claim 11, wherein means for determining net operating profit after tax further comprises means for adding at least one of amortization, net interest on debt, and net after-tax charges to net income.

13. A system according to claim 11, wherein means for determining net operating profit after tax further comprises means for adding each of amortization, net interest on debt, and net after-tax charges to net income.

14. A system according to claim 11, wherein means for determining invested capital further comprises means for adding total debt to adjusted equity.

15. A system according to claim 11, wherein means for determining invested capital further comprises means for adding at least one of pooling premiums, cumulative goodwill, and cumulative net after-tax charges to book value of equity.

16. A system according to claim 11, wherein means for determining invested capital further comprises means for adding each of pooling premiums, cumulative goodwill, and cumulative net after-tax charges to book value of equity.

17. A system according to claim 11, wherein the second predetermined time is approximately one year after the first predetermined time.

18. A system according to claim 11, wherein the net operating profit after tax and the invested capital at the first and second predetermined times are from an individual company.

19. A system according to claim 11, wherein the net operating profit after tax and the invested capital at the first and second predetermined times are from a group of companies.

20. A system for determining incremental return on invested capital, the system comprising:
means for determining net operating profit after tax at a first predetermined time, where net operating profit after tax includes net income, plus amortization, plus net interest on debt, plus net after-tax charges;
means for determining invested capital at the first predetermined time, where invested capital includes book value of equity, plus pooling premiums, plus cumulative goodwill, plus cumulative net after-tax charges, plus total debt;
means for determining net operating profit after tax at a second predetermined time that is approximately one year after the first predetermined time, where net operating profit after tax includes net income, plus amortization, plus net interest on debt, plus net after-tax charges;
means for determining invested capital at the second predetermined time, where invested capital includes book value of equity, plus pooling premiums, plus cumulative goodwill, plus cumulative net after-tax charges, plus total debt;
means for determining a change in net operating profit after tax between the first predetermined time and the second predetermined time;
means for determining a change in invested capital between the first predetermined time and the second predetermined time; and
means for determining the incremental return on invested capital by dividing the change in net operating profit after tax by the change in invested capital.

21. Computer executable software code transmitted as an information signal, the code for determining incremental return on invested capital, the code comprising:
code to determine net operating profit after tax at a first predetermined time;
code to determine invested capital at the first predetermined time;
code to determine net operating profit after tax at a second predetermined time;
code to determine invested capital at the second predetermined time;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

22. Computer executable software code transmitted as an information signal according to claim 21, wherein code to determine net operating profit after tax further comprises code to add at least one of amortization, net interest on debt, and net after-tax charges to net income.

23. Computer executable software code transmitted as an information signal according to claim 21, wherein code to determine net operating profit after tax further comprises code to add each of amortization, net interest on debt, and net after-tax charges to net income.

24. Computer executable software code transmitted as an information signal according to claim 21, wherein code to determine invested capital further comprises code to add total debt to adjusted equity.

25. Computer executable software code transmitted as an information signal according to claim 21, wherein code to determine invested capital further comprises code to add at least one of pooling premiums, cumulative goodwill, and cumulative net after-tax charges to book value of equity.

26. Computer executable software code transmitted as an information signal according to claim 21, wherein code to determine invested capital further comprises code to add each of pooling premiums, cumulative goodwill, and cumulative net after-tax charges to book value of equity.

27. Computer executable software code transmitted as an information signal according to claim 21, wherein the second predetermined time is approximately one year after the first predetermined time.

28. Computer executable software code transmitted as an information signal according to claim 21, wherein the net operating profit after tax and the invested capital at the first and second predetermined times are from an individual company.

29. Computer executable software code transmitted as an information signal according to claim 21, wherein the net operating profit after tax and the invested capital at the first and second predetermined times are from a group of companies.

30. Computer executable software code transmitted as an information signal, the code for determining incremental return on invested capital, the code comprising:
code to determine net operating profit after tax at a first predetermined time, where net operating profit after tax includes net income, plus amortization, plus net interest on debt, plus net after-tax charges;
code to determine invested capital at the first predetermined time, where invested capital includes book value of equity, plus pooling premiums, plus cumulative goodwill, plus cumulative net after-tax charges, plus total debt;
code to determine net operating profit after tax at a second predetermined time that is approximately one year after the first predetermined time, where net operating profit after tax includes net income, plus amortization, plus net interest on debt, plus net after-tax charges;
code to determine invested capital at the second predetermined time, where invested capital includes book value of equity, plus pooling premiums, plus cumulative goodwill, plus cumulative net after-tax charges, plus total debt;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

31. A computer-readable medium having computer executable software code stored thereon, the code for determining incremental return on invested capital, the code comprising:
code to determine net operating profit after tax at a first predetermined time;
code to determine invested capital at the first predetermined time;
code to determine net operating profit after tax at a second predetermined time;
code to determine invested capital at the second predetermined time;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

32. A computer-readable medium according to claim 31, wherein code to determine net operating profit after tax further comprises code to add at least one of amortization, net interest on debt, and net after-tax charges to net income.

33. A computer-readable medium according to claim 31, wherein code to determine net operating profit after tax further comprises code to add each of amortization, net interest on debt, and net after-tax charges to net income.

34. A computer-readable medium according to claim 31, wherein code to determine invested capital further comprises code to add total debt to adjusted equity.

35. A computer-readable medium according to claim 31, wherein code to determine invested capital further comprises code to add at least one of pooling premiums, cumulative goodwill, and cumulative net after-tax charges to book value of equity.

36. A computer-readable medium according to claim 31, wherein code to determine invested capital further comprises code to add each of pooling premiums, cumulative goodwill, and cumulative net after-tax charges to book value of equity.

37. A computer-readable medium according to claim 31, wherein the second predetermined time is approximately one year after the first predetermined time.

38. A computer-readable medium according to claim 31, wherein the net operating profit after tax and the invested capital at the first and second predetermined times are from an individual company.

39. A computer-readable medium according to claim 31, wherein the net operating profit after tax and the invested capital at the first and second predetermined times are from a group of companies.

40. A computer-readable medium having computer executable software code stored thereon, the code for determining incremental return on invested capital, the code comprising:
code to determine net operating profit after tax at a first predetermined time, where net operating profit after tax includes net income, plus amortization, plus net interest on debt, plus net after-tax charges;
code to determine invested capital at the first predetermined time, where invested capital includes book value of equity, plus pooling premiums, plus cumulative goodwill, plus cumulative net after-tax charges, plus total debt;
code to determine net operating profit after tax at a second predetermined time that is approximately one year after the first predetermined time, where net operating profit after tax includes net income, plus amortization, plus net interest on debt, plus net after-tax charges;
code to determine invested capital at the second predetermined time, where invested capital includes book value of equity, plus pooling premiums, plus cumulative goodwill, plus cumulative net after-tax charges, plus total debt;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

41. A programmed computer for determining incremental return on invested capital comprising:
a memory having at least one region for storing computer executable program code; and
a processor for executing the program code stored in the memory, wherein the program code comprises:
code to determine net operating profit after tax at a first predetermined time;
code to determine invested capital at the first predetermined time;
code to determine net operating profit after tax at a second predetermined time;
code to determine invested capital at the second predetermined time;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

42. A programmed computer according to claim 41, wherein code to determine net operating profit after tax further comprises code to add at least one of amortization, net interest on debt, and net after-tax charges to net income.

43. A programmed computer according to claim 41, wherein code to determine net operating profit after tax further comprises code to add each of amortization, net interest on debt, and net after-tax charges to net income.

44. A programmed computer according to claim 41, wherein code to determine invested capital further comprises code to add total debt to adjusted equity.

45. A programmed computer according to claim 41, wherein code to determine invested capital further comprises code to add at least one of pooling premiums, cumulative goodwill, and cumulative net after-tax charges to book value of equity.

46. A programmed computer according to claim 41, wherein code to determine invested capital further comprises code to add each of pooling premiums, cumulative goodwill, and cumulative net after-tax charges to book value of equity.

47. A programmed computer according to claim 41, wherein the second predetermined time is approximately one year after the first predetermined time.

48. A programmed computer according to claim 41, wherein the net operating profit after tax and the invested capital at the first and second predetermined times are from an individual company.

49. A programmed computer according to claim 41, wherein the net operating profit after tax and the invested capital at the first and second predetermined times are from a group of companies.

50. A programmed computer for determining incremental return on invested capital comprising:
a memory having at least one region for storing computer executable program code; and
a processor for executing the program code stored in the memory, wherein the program code comprises:
code to determine net operating profit after tax at a first predetermined time, where net operating profit after tax includes net income, plus amortization, plus net interest on debt, plus net after-tax charges;
code to determine invested capital at the first predetermined time, where invested capital includes book value of equity, plus pooling premiums, plus cumulative goodwill, plus cumulative net after-tax charges, plus total debt;
code to determine net operating profit after tax at a second predetermined time that is approximately one year after the first predetermined time, where net operating profit after tax includes net income, plus amortization, plus net interest on debt, plus net after-tax charges;
code to determine invested capital at the second predetermined time, where invested capital includes book value of equity, plus pooling premiums, plus cumulative goodwill, plus cumulative net after-tax charges, plus total debt;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

51. A method for estimating a trend of future incremental return on invested capital, the method comprising:
determining a relative forward price to earnings ratio; and
estimating the trend of incremental return on invested capital at a predetermined future time using the relative forward price to earnings ratio, where the incremental return on invested capital is the result of:
determining net operating profit after tax at a first predetermined time;
determining invested capital at the first predetermined time;
determining net operating profit after tax at a second predetermined time;
determining invested capital at the second predetermined time;
determining a change in net operating profit after tax between the first predetermined time and the second predetermined time;
determining a change in invested capital between the first predetermined time and the second predetermined time; and
determining the incremental return on invested capital by dividing the change in net operating profit after tax by the change in invested capital.

52. A method for estimating a trend of future incremental return on invested capital, the method comprising:
determining a relative forward price to earnings ratio; and
estimating the trend of incremental return on invested capital at least two years in the future using the relative forward price to earnings ratio, where the incremental return on invested capital is the result of:
determining net operating profit after tax at a first predetermined time, where net operating profit after tax includes net income, plus amortization, plus net interest on debt, plus net after-tax charges;
determining invested capital at the first predetermined time, where invested capital includes book value of equity, plus pooling premiums, plus cumulative goodwill, plus cumulative net after-tax charges, plus total debt;
determining net operating profit after tax at a second predetermined time that is approximately one year after the first predetermined time, where net operating profit after tax includes net income, plus amortization, plus net interest on debt, plus net after-tax charges;
determining invested capital at the second predetermined time, where invested capital includes book value of equity, plus pooling premiums, plus cumulative goodwill, plus cumulative net after-tax charges, plus total debt;
determining a change in net operating profit after tax between the first predetermined time and the second predetermined time;
determining a change in invested capital between the first predetermined time and the second predetermined time; and
determining the incremental return on invested capital by dividing the change in net operating profit after tax by the change in invested capital.

53. A system for estimating a trend of future incremental return on invested capital, the system comprising:
means for determining a relative forward price to earnings ratio; and
means for estimating the trend of incremental return on invested capital at a predetermined future time using the relative forward price to earnings ratio, where the incremental return on invested capital is determined by:
means for determining net operating profit after tax at a first predetermined time;
means for determining invested capital at the first predetermined time;
means for determining net operating profit after tax at a second predetermined time;
means for determining invested capital at the second predetermined time;
means for determining a change in net operating profit after tax between the first predetermined time and the second predetermined time;
means for determining a change in invested capital between the first predetermined time and the second predetermined time; and
means for determining the incremental return on invested capital by dividing the change in net operating profit after tax by the change in invested capital.

54. A system for estimating a trend of future incremental return on invested capital, the system comprising:
means for determining a relative forward price to earnings ratio; and
means for estimating the trend of incremental return on invested capital at least two years in the future using the relative forward price to earnings ratio, where the incremental return on invested capital is determined by:
means for determining net operating profit after tax at a first predetermined time, where net operating profit after tax includes net income, plus amortization, plus net interest on debt, plus net after-tax charges;
means for determining invested capital at the first predetermined time, where invested capital includes book value of equity, plus pooling premiums, plus cumulative goodwill, plus cumulative net after-tax charges, plus total debt;
means for determining net operating profit after tax at a second predetermined time that is approximately one year after the first predetermined time, where net operating profit after tax includes net income, plus amortization, plus net interest on debt, plus net after-tax charges;
means for determining invested capital at the second predetermined time, where invested capital includes book value of equity, plus pooling premiums, plus cumulative goodwill, plus cumulative net after-tax charges, plus total debt;
means for determining a change in net operating profit after tax between the first predetermined time and the second predetermined time;
means for determining a change in invested capital between the first predetermined time and the second predetermined time; and
means for determining the incremental return on invested capital by dividing the change in net operating profit after tax by the change in invested capital.

55. Computer executable software code transmitted as an information signal, the code for estimating a trend of future incremental return on invested capital, the code comprising:
code to determine a relative forward price to earnings ratio; and
code to estimate the trend of incremental return on invested capital at a predetermined future time using the relative forward price to earnings ratio, where the incremental return on invested capital is the result of:
code to determine net operating profit after tax at a first predetermined time;
code to determine invested capital at the first predetermined time;
code to determine net operating profit after tax at a second predetermined time;
code to determine invested capital at the second predetermined time;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

56. Computer executable software code transmitted as an information signal, the code for estimating a trend of future incremental return on invested capital, the code comprising:
code to determine a relative forward price to earnings ratio; and
code to estimate the trend of incremental return on invested capital at least two years in the future using the relative forward price to earnings ratio, where the incremental return on invested capital is the result of:
code to determine net operating profit after tax at a first predetermined time, where net operating profit after tax includes net income, plus amortization, plus net interest on debt, plus net after-tax charges;
code to determine invested capital at the first predetermined time, where invested capital includes book value of equity, plus pooling premiums, plus cumulative goodwill, plus cumulative net after-tax charges, plus total debt;
code to determine net operating profit after tax at a second predetermined time that is approximately one year after the first predetermined time, where net operating profit after tax includes net income, plus amortization, plus net interest on debt, plus net after-tax charges;
code to determine invested capital at the second predetermined time, where invested capital includes book value of equity, plus pooling premiums, plus cumulative goodwill, plus cumulative net after-tax charges, plus total debt;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

57. A computer-readable medium having computer executable software code stored thereon, the code for estimating a trend of future incremental return on invested capital, the code comprising:
code to determine a relative forward price to earnings ratio; and
code to estimate the trend of incremental return on invested capital at a predetermined future time using the relative forward price to earnings ratio, where the incremental return on invested capital is the result of:
code to determine net operating profit after tax at a first predetermined time;
code to determine invested capital at the first predetermined time;
code to determine net operating profit after tax at a second predetermined time;
code to determine invested capital at the second predetermined time;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

58. A computer-readable medium having computer executable software code stored thereon, the code for estimating a trend of future incremental return on invested capital, the code comprising:
code to determine a relative forward price to earnings ratio; and
code to estimate the trend of incremental return on invested capital at least two years in the future using the relative forward price to earnings ratio, where the incremental return on invested capital is the result of:
code to determine net operating profit after tax at a first predetermined time, where net operating profit after tax includes net income, plus amortization, plus net interest on debt, plus net after-tax charges;
code to determine invested capital at the first predetermined time, where invested capital includes book value of equity, plus pooling premiums, plus cumulative goodwill, plus cumulative net after-tax charges, plus total debt;
code to determine net operating profit after tax at a second predetermined time that is approximately one year after the first predetermined time, where net operating profit after tax includes net income, plus amortization, plus net interest on debt, plus net after-tax charges;
code to determine invested capital at the second predetermined time, where invested capital includes book value of equity, plus pooling premiums, plus cumulative goodwill, plus cumulative net after-tax charges, plus total debt;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

59. A programmed computer for estimating a trend of future incremental return on invested capital comprising:
a memory having at least one region for storing computer executable program code; and
a processor for executing the program code stored in the memory, wherein the program code comprises:
code to determine a relative forward price to earnings ratio; and
code to estimate the trend of incremental return on invested capital at a predetermined future time using the relative forward price to earnings ratio, where the incremental return on invested capital is the result of:
code to determine net operating profit after tax at a first predetermined time;
code to determine invested capital at the first predetermined time;
code to determine net operating profit after tax at a second predetermined time;
code to determine invested capital at the second predetermined time;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.

60. A programmed computer for estimating a trend of future incremental return on invested capital comprising:
a memory having at least one region for storing computer executable program code; and
a processor for executing the program code stored in the memory, wherein the program code comprises:
code to determine a relative forward price to earnings ratio; and
code to estimate the trend of incremental return on invested capital at least two years in the future using the relative forward price to earnings ratio, where the incremental return on invested capital is the result of:
code to determine net operating profit after tax at a first predetermined time, where net operating profit after tax includes net income, plus amortization, plus net interest on debt, plus net after-tax charges;
code to determine invested capital at the first predetermined time, where invested capital includes book value of equity, plus pooling premiums, plus cumulative goodwill, plus cumulative net after-tax charges, plus total debt;
code to determine net operating profit after tax at a second predetermined time that is approximately one year after the first predetermined time, where net operating profit after tax includes net income, plus amortization, plus net interest on debt, plus net after-tax charges;
code to determine invested capital at the second predetermined time, where invested capital includes book value of equity, plus pooling premiums, plus cumulative goodwill, plus cumulative net after-tax charges, plus total debt;
code to determine a change in net operating profit after tax between the first predetermined time and the second predetermined time;
code to determine a change in invested capital between the first predetermined time and the second predetermined time; and
code to determine the incremental return on invested capital by dividing the change in net operating profit after tax by the change in invested capital.
